(19) United States
(12) Patent Application Publication
(10) Pub. No.: US 2026/0088363 A1
(43) Pub. Date: Mar. 26, 2026

(54) SOLID-STATE BATTERY AND METHOD FOR PRODUCING SAME

(71) Applicant: FDK CORPORATION, Minato-ku, Tokyo (JP)

(72) Inventors: Masakazu Kobayashi, Tokyo (JP); Satoshi Higuchi, Tokyo (JP)

(21) Appl. No.: 19/109,586

(22) PCT Filed: May 30, 2023
(86) PCT No.: PCT/JP2023/020105

§ 371 Date: Mar. 7, 2025

(30) Foreign Application Priority Data
Sep. 29, 2022 (JP) 2022-156663

(51) Int. Cl. H01M 10/0585; H01M 4/02; H01M 4/04; H01M 4/136; H01M 4/1397; H01M 10/0525; H01M 10/0562

(52) U.S. Cl. CPC H01M 10/0585; H01M 4/0471; H01M 4/136; H01M 4/1397; H01M 10/0525; H01M 10/0562; H01M 2004/021; H01M 2004/028

(57) ABSTRACT

The present application provides a solid-state battery that eliminates the need for additional components such as conductive resin layers, makes it possible to enhance cycle characteristics, and can also be applied to solid-state batteries in which oxide-based solid electrolytes are used. The present application also provides a method for producing the solid-state battery. The present invention is intended to solve the problems described above and relates to a solid-state battery including a positive electrode layer, a negative electrode layer, and a solid electrolyte layer arranged between the positive electrode layer and the negative electrode layer, in which the ratio (negative electrode capacity/positive electrode capacity) of the charge storage capacity of the negative electrode layer to the charge storage capacity of the positive electrode layer is 0.74-0.96.

### TECHNICAL FIELD

The present invention relates to a solid-state battery and a method for producing the same.

### BACKGROUND ART

In recent years, with the rapid development of technologies related to information-related equipment, communication equipment, and transportation-related equipment, such as personal computers, mobile phones (smartphones), and electric vehicles, the development of batteries as power sources for these devices has become increasingly important. Lithium-ion secondary batteries and solid-state batteries, which are highly safe and have high energy density, have attracted attention as batteries for use in these applications.

Among these batteries, a lithium-ion secondary battery that uses a flammable organic electrolyte liquid for an electrolyte layer disposed between a positive electrode active material layer and a negative electrode active material layer requires safety measures to prevent liquid leakage and the resulting ignition and short circuit, as well as overcharging. In particular, when the battery is increased in capacity or energy density, these risks also increase, necessitating further safety measures. In contrast, a solid-state battery that uses a solid electrolyte for the electrolyte layer without using an organic electrolyte liquid is known to be less likely to cause the above-described problems and to have higher safety. For this reason, the development of solid-state batteries is underway.

These secondary batteries are also required to have improved cycle characteristics, which means that their capacity does not easily decrease even with repeated use. Various methods for improving the cycle characteristics of solid-state batteries have also been studied.

For example, PTL 1 describes an all-solid-state lithium ion battery having the following features: the solid-state battery includes a carbon-based material as a negative electrode active material and has a BET specific surface area of particles of the negative electrode active material of 27.4 m²/g or less, in which a ratio (X/Y) of a theoretical capacity (X) of a positive electrode active material layer to a theoretical capacity (Y) of a negative electrode active material layer in a portion where a positive electrode and a negative electrode overlap with each other is 1.03 or more and 1.20 or less; and a ratio (A/B) of an area (A) of the positive electrode active material layer to an area (B) of the negative electrode active material layer is 1 or more and 1.24 or less.

According to PTL 1, the decrease in the capacity retention rate has been prevented by setting the theoretical electric capacity ratio of the negative electrode to the positive electrode to 1.2 or more. However, it is said that when the electric capacity ratio of the negative electrode is increased, the total surface area of the negative electrode active material increases, causing a reaction between moisture and Li ions on the particle surface of the negative electrode active material, thereby reducing the amount of Li ions that can contribute to charge and discharge. In PTL 1, to address such a problem, the amount of the negative electrode active material is reduced (X/Y is increased) to suppress the reaction between moisture and Li ions on the particle surface of the negative electrode active material, thereby preventing a decrease in the amount of Li ions and improving the capacity retention rate (cycle characteristics).

Further, PTL 2 describes an electrode for an all-solid-state lithium ion battery, in which an electrode active material layer is fixed to a current collector layer via a conductive resin layer. According to PTL 2, by adhering the conductive resin layer to the electrode active material layer, even when a volume change of the electrode active material occurs due to charging and discharging, the conductive resin layer and the current collector layer are less likely to separate from each other. Furthermore, it is said that, as a result, particles such as the electrode active material and the conductive additive are also less likely to separate from each other, thereby improving the charge-discharge characteristics such as the charge-discharge capacity density and the cycle characteristics.

Further, PTL 3 describes a thin-film solid-state secondary battery in which a ratio X of the film thickness of a positive electrode active material layer to the film thickness a negative electrode active material layer satisfies a conditional expression of 0.2R≤X≤10R where R is defined as the ratio of a reciprocal of a maximum charge-discharge capacity per unit volume of the positive electrode active material layer to the negative electrode active material layer. PTL 3 teaches that X=R, that is, the positive electrode film thickness/negative electrode film thickness (X) is preferably equal to (the maximum charge-discharge capacity per unit volume of the negative electrode)/(maximum charge-discharge capacity per unit volume of the positive electrode) (Y). At this time, the amounts of lithium ions that can be inserted into and detached from the positive electrode layer and the negative electrode layer become substantially equal to each other, and thus, the lithium ions can be inserted into and detached from the positive electrode and the negative electrode without excess or deficiency, resulting in the maximum battery capacity per unit volume. Further, PTL 3 teaches that no significant problem occurs in the cycle characteristics at this time.

### CITATION LIST

### Patent Literature

### PTL 1

Japanese Patent Application Laid-Open No. 2018-6055

### PTL 2

Japanese Patent Application Laid-Open No. 2013-93156

### PTL 3

Japanese Patent Application Laid-Open No. 2007-103130

### SUMMARY OF INVENTION

### Technical Problem

As described in PTLs 1 to 3, various attempts have been made to improve the cycle characteristics of solid-state batteries.

However, a negative electrode using a carbon-based material as the negative electrode active material described in PTL 1 cannot be used in a solid-state battery that employs an oxide-based solid electrolyte, which is fired during the production. This is because the carbon-based material causes the solid electrolyte, such as LAGP, to undergo reduction decomposition during charge and discharge, or it disappears during the firing. The technology described in PTL 1 is used almost exclusively in batteries that employ a sulfide-based electrolyte as the solid electrolyte.

In addition, in an electrode having a conductive resin layer described in PTL 2, the efficiency of extracting electricity from the electrode active material to the current collector is reduced by the conductive resin layer, making it difficult to increase the energy density of the battery.

Further, PTL 3 only describes making the capacity of the positive electrode and the capacity of the negative electrode substantially equal, and does not provide any technological improvement over a conventional solid-state battery.

The present invention has been made in view of the above-described problems, and an object thereof is to provide a solid-state battery and a method for producing the same, which are applicable to a solid-state battery using an oxide-based solid electrolyte, and which can enhance cycle characteristics without requiring an additional configuration such as a conductive resin layer.

### Solution to Problem

The above-described problem can be solved by the following solid-state battery and method for producing a solid-state battery.

A solid-state battery of the present invention includes: a positive electrode layer; a negative electrode layer; and a solid electrolyte layer disposed between the positive electrode layer and the negative electrode layer. In solid-state battery, a ratio (negative electrode capacity/positive electrode capacity) of a charging capacity of the negative electrode layer to a charging capacity of the positive electrode layer is 0.74 or more and 0.96 or less.

A method of the present invention for producing a solid-state battery includes: forming a stacked body, the stacked body including a positive electrode mixture layer, a negative electrode mixture layer, and an electrolyte mixture layer disposed between the positive electrode mixture layer and the negative electrode mixture layer; and firing the stacked body. In the fired stacked body, a ratio (negative electrode capacity/positive electrode capacity) of a charging capacity of the negative electrode mixture layer to a charging capacity of the positive electrode mixture layer is 0.74 or more and 0.96 or less.

### Advantageous Effects of Invention

The present invention provides a solid-state battery that can be applied to a solid-state battery using an oxide-based solid electrolyte and that can enhance cycle characteristics without requiring an additional configuration such as a conductive resin layer, and a method for producing the solid-state battery.

### BRIEF DESCRIPTION OF DRAWINGS

FIGS. 1A to 1C are schematic views illustrating a configuration of a solid-state battery according to the present embodiment;

FIGS. 2A to 2E are schematic views illustrating exemplary producing steps of a positive electrode mixture layer part;

FIGS. 3A to 3C are schematic views illustrating an example of the produced positive electrode mixture layer part;

FIGS. 4A to 4C are schematic views illustrating an example of a produced negative electrode mixture layer part;

FIGS. 5A to 5C are schematic views illustrating exemplary steps of producing a solid-state battery main body;

FIGS. 6A to 6C are schematic views illustrating exemplary steps of producing a solid-state battery main body; and

FIG. 7 is a graph illustrating the cycle characteristics of the examples and comparative examples.

### DESCRIPTION OF EMBODIMENTS

### 1. Solid-State Battery

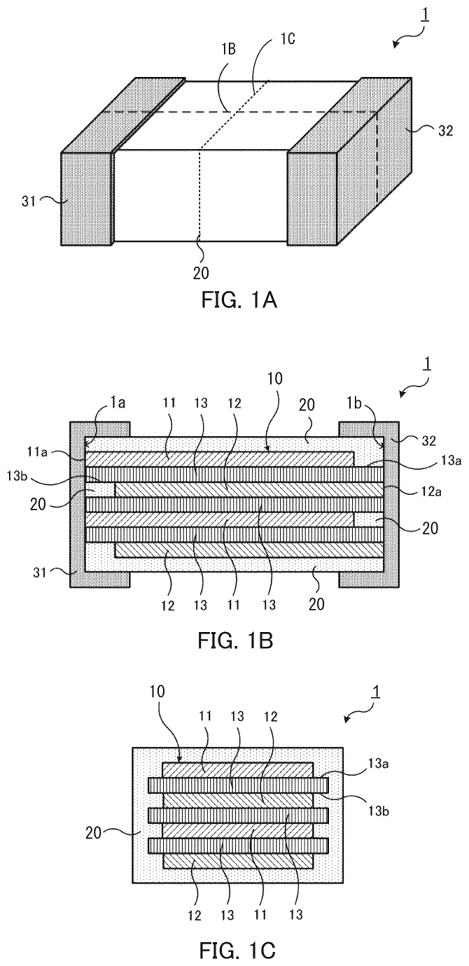

FIGS. 1A to 1C are schematic views illustrating a configuration of solid-state battery 1 according to the present embodiment. FIG. 1A is a schematic perspective view of a main part of a solid-state battery, FIG. 1B is a schematic cross-sectional view taken along line 1B of FIG. 1A, and FIG. 1C is a schematic cross-sectional view taken along line 1C of FIG. 1A.

As illustrated in FIGS. 1A to 1C, solid-state battery 1 includes solid-state battery main body 10, protection layer 20, and external electrodes 31 and 32.

### 1-1. Solid-State Battery Main Body 10

Solid-state battery main body 10 includes positive electrode layer 11, negative electrode layer 12, and solid electrolyte layer 13 disposed between positive electrode layer 11 and negative electrode layer 12. In the present embodiment, a plurality of positive electrode layers 11, a plurality of negative electrode layers 12, and a plurality of solid electrolyte layers 13 are stacked in such a way that solid electrolyte layer 13 is interposed between positive electrode layer 11 and negative electrode layer 12. That is, solid-state battery main body 10 of the present embodiment has a structure in which negative electrode layer 12, solid electrolyte layer 13, positive electrode layer 11, solid electrolyte layer 13, negative electrode layer 12, solid electrolyte layer 13, and positive electrode layer 11 are stacked in this order from the bottom.

### (Positive Electrode Layer 11)

Positive electrode layer 11 is disposed on a portion of one surface 13a (i.e., one of the surfaces) of solid electrolyte layer 13.

Positive electrode layer 11 includes a positive electrode active material. Examples of the positive electrode active material include layered oxides such as lithium cobaltate (LiCoO₂) and lithium nickelate (LiNiO₂), compounds having an olivine structure such as lithium cobalt pyrophosphate (Li₂CoP₂O₇, hereinafter also referred to as “LCPO”) and lithium cobalt phosphate (LiCoPO₄), lithium manganese oxide having a spinel structure such as LiMO₂ (where M is one or more of Ni, Mn, and Co), lithium titanate, phosphate compounds such as lithium vanadium phosphate (Li₃V₂ (PO₄)₃, hereinafter also referred to as “LVP”), Li₂FeP₂O₇, Li₂CoP₂O₇, Li₂NiP₂O₇, and Li₂MnP₂O₇, and the like.

Positive electrode layer 11 may further include a solid electrolyte and/or a conductive additive as necessary. Examples of the solid electrolyte that may be included in positive electrode layer 11 include the same materials as those used in solid electrolyte layer 13 described below, and preferably, an oxide solid electrolyte such as LAGP described below is used. Examples of the conductive additive include carbon materials such as carbon fibers, carbon black, graphite, graphene, and carbon nanotubes.

The thickness of positive electrode layer 11 is not particularly limited, but is, for example, 1 μm or more and 35 μm or less, preferably 6 μm or more and 25 μm or less. When the thickness of positive electrode layer 11 is equal to or greater than the lower limit value, the discharge capacity is further increased.

### (Negative Electrode Layer 12)

Negative electrode layer 12 is provided on a portion of the other surface 13b (i.e., the other one of the surfaces) of solid electrolyte layer 13. As illustrated in FIG. 1B, positive electrode layer 11 and negative electrode layer 12, which form a pair, are disposed to partially overlap each other with solid electrolyte layer 13 therebetween.

Negative electrode layer 12 includes a negative electrode active material. Examples of the negative electrode active material include carbon materials such as natural graphite, artificial graphite, and graphite carbon fibers, metal oxides such as anatase-type titanium oxide, LATP, LVP, and lithium titanate (Li₄Ti₅O₁₂), metals such as silicon (Si) and tin (Sn), niobium oxide (Nb₂O₅), and metal silicides such as that of nickel (Ni). Among these, anatase-type titanium oxide is preferable. The negative electrode active material may be of one type or a combination of two or more types.

Negative electrode layer 12 may further include a solid electrolyte or a conductive additive as necessary. The solid electrolyte and/or conductive additive used in negative electrode layer 12 may be the same as those used in positive electrode layer 11. Negative electrode layer 12 preferably includes the same type of solid electrolyte as positive electrode layer 11.

The thickness of negative electrode layer 12 is not particularly limited, but is, for example, 1 μm or more and 25 μm or less, preferably 6 μm or more and 20 μm or less. When the thickness of negative electrode layer 12 is equal to or greater than the lower limit value, the discharge capacity is further increased.

### (Solid Electrolyte Layer 13)

Solid electrolyte layer 13 includes a solid electrolyte. Examples of the solid electrolyte include oxide solid electrolytes, sulfide solid electrolytes, nitride solid electrolytes, halide solid electrolytes, and the like. Among these, an oxide solid electrolyte is preferable. Examples of the oxide solid electrolyte include Na super ionic conductor-type (also referred to as “NASICON-type”) oxide solid electrolytes represented by the general formula Li_{1+y}Al_{y}M_{2-y}(PO₄)₃. In the above general formula, composition ratio y is 0<y≤1, and M is one or both of germanium (Ge) and titanium (Ti). The NASICON-type oxide solid electrolyte is preferably LAGP. LAGP is an oxide solid electrolyte represented by the general formula Li₁₊ₓAlₓGe₂₋ₓ(PO₄)₃ (0<x≤1), and is referred to as aluminum-substituted lithium germanium phosphate or the like. For example, Li_{1.5}Al_{0.5}Ge_{1.5}(PO₄)₃ with a composition ratio of x=0.5 is preferable as LAGP of solid electrolyte layer 13. Further, LAGP is not limited to the composition of Li_{1.5}Al_{0.5}Ge_{1.5}(PO₄)₃, and a NASICON-type LAGP having a different composition, such as Li_{1.4}Al_{0.4}Ge_{1.6}(PO₄)₃ may be used. LAGP may be an amorphous LAGP, a crystalline LAGP, or a combination thereof.

The thickness of solid electrolyte layer 13 is not particularly limited, but is, for example, 0.1 μm or more and 50 μm or less, preferably 1 μm or more and 10 μm or less. When the thickness of solid electrolyte layer 13 is equal to or greater than the lower limit value, the insulation property between positive electrode layer 11 and negative electrode layer 12 is further enhanced. When the thickness is equal to or less than the upper limit value, the diffusion distance of Li ions becomes smaller, which can reduce the internal resistance of solid-state battery 1.

In solid-state battery main body 10 configured as described above, during charging, lithium ions are transmitted from positive electrode layer 11 to negative electrode layer 12 through solid electrolyte layer 13 and are taken in, and during discharging, lithium ions are transmitted from negative electrode layer 12 through solid electrolyte layer 13 to positive electrode layer 11 to be taken in. By such lithium ion transmission, the charge and discharge operations are performed.

### (Charging Capacity Ratio)

In solid-state battery main body 10 according to the present embodiment, the ratio (negative electrode capacity/positive electrode capacity) of the charging capacity of the negative electrode layer 12 to the charging capacity of the positive electrode layer 11 is 0.7 or more and 1.0 or less.

Here, the charging capacity of positive electrode layer 11 and the charging capacity of negative electrode layer 12 mean the amounts of electricity (unit is μAh) that positive electrode layer 11 and negative electrode layer 12 can be charged and discharged. The charging capacity of positive electrode layer 11 and the charging capacity of negative electrode layer 12 may be values obtained by multiplying the theoretical capacities (unit: μAh/g) of the active material included in positive electrode layer 11 and negative electrode layer 12 by the added amounts (unit: g) of the active materials, respectively.

The theoretical capacity of the active material used in the above calculation may be referred to as a literature value. Further, the type of active material may be determined by X-ray diffraction (XRD) or the like, and the amount of active material may be determined by energy dispersive X-ray analysis (EDX) or the like (determined from the composition ratio of positive electrode layer 11 and negative electrode layer 12). The charging capacities of positive electrode layer 11 and negative electrode layer 12 may be determined using these measurement results and the theoretical capacities of the respective active material.

Conventional lithium-ion secondary batteries have been designed so that the charging capacity of the negative electrode is larger than that of the positive electrode for reasons such as sufficiently accommodating lithium ions in the negative electrode to prevent lithium deposition and maintaining a chargeable and dischargeable capacity even when the negative electrode active material deteriorates due to overdischarge. According to the findings of the present inventors, unlike conventional lithium ion secondary batteries using liquid electrolytes, the positive electrode active material is more susceptible to degradation than the negative electrode active material in a solid-state battery, and the crystal structure of the positive electrode active material tends to deteriorate under high potential, and therefore, the positive electrode active material is more likely to deteriorate first. Therefore, it is considered that, in a solid-state battery, decrease in the cycle characteristics (battery capacity during repeated use) due to the deterioration of the positive electrode active material can be prevented by making the positive electrode charging capacity larger than the negative electrode charging capacity.

According to the findings of the present inventors, the deterioration of the positive electrode active material is more likely to occur when lithium metal phosphate is used as the positive electrode active material. For this reason, the effect of improving the cycle characteristics by increasing the charging capacity of the positive electrode more than the charging capacity of the negative electrode is remarkably exhibited when lithium metal phosphate is used as the positive electrode active material.

When the charging capacity of the positive electrode is excessive with respect to the charging capacity of the negative electrode (when the ratio between the charging capacities is too small), the cycle characteristics of the battery are rather decreased due to overdischarge. For this reason, in the present embodiment, the ratio between the above-described charging capacities is set to 0.7 or more and 1.0 or less. From the viewpoint of balancing these factors, the ratio between the above-described charging capacities is preferably 0.74 or more and 0.96 or less, and more preferably 0.74 or more and 0.78 or less or 0.90 or more and 0.96 or less.

The charging capacity of positive electrode layer 11 and the charging capacity of negative electrode layer 12 can be adjusted to fall within the above range by changing the type of the positive electrode active material or the negative electrode active material or combination thereof to change the theoretical capacities, or by changing the thicknesses of positive electrode layer 11 and negative electrode layer 12. In the present embodiment, solid-state battery main body 10 includes a plurality of positive electrode layers 11 and a plurality of negative electrode layers 12. In such a case, the charging capacity of positive electrode layer 11 and the charging capacity of negative electrode layer 12 are the total of the charging capacities of a plurality of positive electrode layers 11 and the total of the charging capacities of a plurality of negative electrode layers 12, respectively. Further, the thickness of positive electrode layer 11 and the thickness of negative electrode layer 12 are the total thickness of a plurality of positive electrode layers 11 and the total thickness of a plurality of negative electrode layers 12, respectively.

Further, from the same viewpoint, the ratio of the thickness of negative electrode layer 12 to the thickness of positive electrode layer 11 (negative electrode thickness/positive electrode thickness) is preferably 0.7 or more and 1.0 or less, more preferably 0.7 or more and 0.9 or less, and further preferably 0.7 or more and 0.8 or less.

### 1-2. Protection Layer 20

Protection layer 20 covers solid-state battery main body 10 in such a way that end surface 11a of positive electrode layer 11 and end surface 12a of negative electrode layer 12 are exposed (see FIG. 1B). The surface of solid-state battery main body 10, where end surface 11a of positive electrode layer 11 is exposed from protection layer 20, becomes positive electrode lead-out surface 1a, and the surface of solid-state battery main body 10, where end surface 12a of negative electrode layer 12 is exposed from protection layer 20, becomes negative electrode lead-out surface 1b. As described above, by covering the periphery of solid-state battery main body 10 with protection layer 20, it is possible to protect solid-state battery main body 10 from forces applied from the outside and from the external environment.

Protection layer 20 has electronic insulation and preferably has low permeability to moisture and gas and satisfactory sealing properties. In particular, a protection layer having a thermal expansion coefficient equivalent to that of each layer constituting solid-state battery main body 10 or a protection layer having satisfactory adhesion to each layer is preferable. As a material constituting protection layer 20, for example, a solid electrolyte used for solid electrolyte layer 13, glass, or ceramics is used. 1-3. External Electrodes 31 and 32

External electrode 31 is provided on positive electrode lead-out surface 1a of solid-state battery 1 and is connected to end surfaces 11a of positive electrode layers 11 exposed from positive electrode lead-out surface 1a (see FIG. 1B). External electrode 32 is provided on negative electrode lead-out surface 1b of solid-state battery 1 and is connected to end surfaces 12a of negative electrode layers 12 exposed from negative electrode lead-out surface 1b (see FIG. 1B).

Various conductor materials can be used for external electrode 31 and external electrode 32. For example, external electrode 31 and external electrode 32 are formed by drying and curing a conductive paste containing metal particles such as silver (Ag) or conductive particles such as carbon particles, or by depositing various metals using a sputtering method, a plating method, or the like.

### 1-4. Action

Solid-state battery 1 according to the above embodiment has a ratio of the charging capacity of negative electrode layer 12 to the charging capacity of positive electrode layer 11 (i.e., the ratio of negative electrode capacity/positive electrode capacity) of 0.7 or more and 1.0 or less. Thus, it is possible to enhance the cycle characteristics of solid-state battery 1.

### 2. Method for Producing Solid-State Battery

Solid-state battery 1 according to the present embodiment can be produced through the following steps: 1) preparing a negative electrode paste (negative electrode mixture), a positive electrode paste (positive electrode mixture), an electrolyte paste (electrolyte mixture), and a protection paste (protection material): 2) forming a stacked body including a negative electrode mixture layer obtained from the negative electrode paste, a positive electrode mixture layer, and an electrolyte mixture layer; and 3) firing the stacked body.

### 1) Step of Preparing Negative Electrode Paste or the Like

First, a negative electrode paste is prepared. The negative electrode paste includes a negative electrode active material, and may further include a solid electrolyte, a conductive additive, a binder, a dispersant, a plasticizer, a diluent, and the like as necessary. For example, the negative electrode paste may include anatase-type titanium oxide particles as a negative electrode active material, an oxide solid electrolyte (preferably LAGP) as a solid electrolyte, a conductive additive, a binder, a dispersant, and a diluent (organic solvent).

Further, a positive electrode paste (positive electrode mixture), an electrolyte paste (electrolyte mixture), and a protection paste (protection material) are prepared in the same manner.

### (Positive Electrode Paste)

The positive electrode paste includes a positive electrode active material, and may further include a solid electrolyte, a conductive additive, a binder, a dispersant, a plasticizer, a diluent, and the like as necessary. For example, the positive electrode paste may include a positive electrode active material such as LCPO, an oxide solid electrolyte such as LAGP, a conductive additive such as carbon nanofiber, a binder, and a diluent.

### (Electrolyte Paste)

The electrolyte paste includes a solid electrolyte, and may further include a solid electrolyte, a conductive additive, a binder, a dispersant, a plasticizer, a diluent, and the like as necessary. For example, the electrolyte paste may include a solid electrolyte such as LAGP and a diluent.

### (Protection Paste)

As the protection paste, an electrolyte paste may be used, or a paste containing a glass component or a ceramic component such as Al₂O₃ may be used.

### 2) Step of Forming Stacked Body

Next, stacked body 44 including positive electrode mixture layer 41, negative electrode mixture layer 42, electrolyte mixture layer 43, protective material layer 21, and protective sheet 22 is formed using the above pastes. In the present embodiment, a positive electrode mixture layer part and a negative electrode mixture layer part are produced and stacked, thereby forming stacked body 44.

### (Production of Positive Electrode Mixture Layer Part)

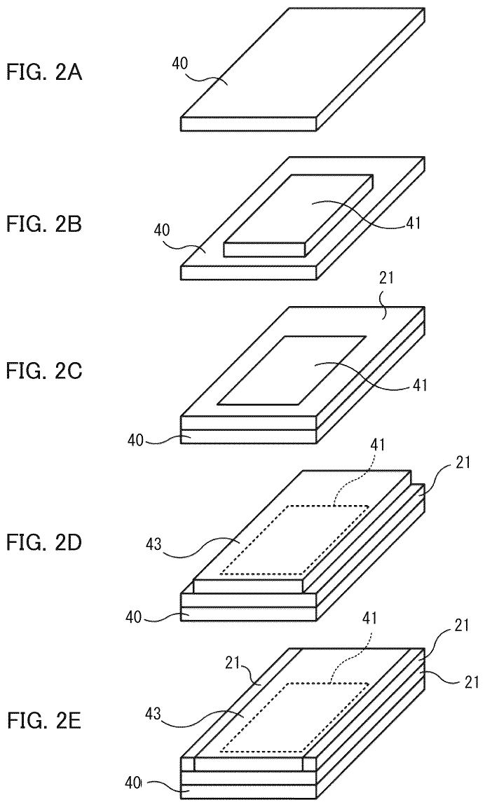

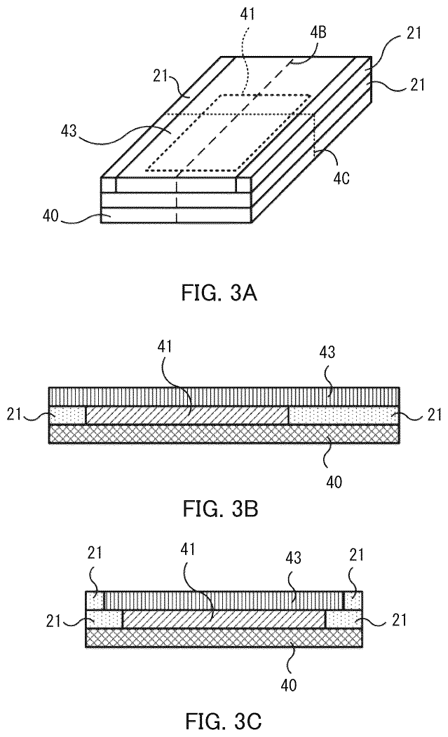

FIGS. 2A to 2E are schematic views illustrating exemplary producing steps of a positive electrode mixture layer part. FIGS. 3A to 3C are schematic views illustrating an example of a produced positive electrode mixture layer part. FIG. 3A is a schematic perspective view of the positive electrode mixture layer part, FIG. 3B is a schematic cross-sectional view along line 4B in FIG. 3A, and FIG. 3C is a schematic cross-sectional view along line 4C in FIG. 3A.

First, a positive electrode paste is applied on a portion of support 40, for example, by a screen printing method, and then dried to form positive electrode mixture layer 41 (FIGS. 2A and 2B). Next, a protection paste is applied around positive electrode mixture layer 41 formed on the portion of support 40, for example, by a screen printing method, and is dried to form protective material layer 21 (embedding layer) (see FIG. 2C).

The application of the positive electrode paste and the application of the protection paste around the positive electrode paste may be performed alternately and repeatedly a plurality of times for adjusting the thickness of positive electrode mixture layer 41 and the amount of active material. In this case, the drying of the positive electrode paste and the protection paste may be performed each time after each application, or may be performed collectively after the plurality of applications of the positive electrode paste and the protection paste.

Next, an electrolyte paste is applied on positive electrode mixture layer 41 and on a portion of protective material layer 21 formed around positive electrode mixture layer 41, for example, by a screen printing method, and is dried to form electrolyte mixture layer 43 (see FIG. 2D). After the formation of electrolyte mixture layer 43, a protective paste is applied on a portion of protective material layer 21 (a portion that is not covered by electrolyte mixture layer 43) by, for example, a screen printing method and dried to form protective material layer 21 (embedding layer) (see FIG. 2E). In this manner, a positive electrode mixture layer part is obtained (see FIG. 3A).

The application of the electrolyte paste and the application of the protection paste on the outside of the electrolyte paste may be performed alternately and repeatedly a plurality of times for adjusting the thickness of electrolyte mixture layer 43 or the like. In this case, the drying of the electrolyte paste and the protective paste may be performed each time after each application, or may be performed collectively after the plurality of applications of the electrolyte paste and the protective paste.

A positive electrode mixture layer part obtained by peeling support 40 from the positive electrode mixture layer part illustrated in FIGS. 3A to 3C can also be used as a positive electrode mixture layer part. Further, the part as shown in FIG. 2C or a part obtained by peeling support 40 therefrom may be used as a positive electrode mixture layer part before forming electrolyte mixture layer 43.

Further, an example in which positive electrode mixture layer 41 and protective material layer 21 around positive electrode mixture layer 41 are formed on support 40, and then, electrolyte mixture layer 43 and protective material layer 21 outside electrolyte mixture layer 43 are formed has been described, but the formation order can be reversed. That is, after forming electrolyte mixture layer 43 and protective material layer 21 on the outside thereof on support 40, positive electrode mixture layer 41 and protective material layer 21 around positive electrode mixture layer 41 may be formed.

Further, each layer may be directly applied onto support 40, or may be formed by being transferred onto support 40 after being applied onto another release film (for example, a PET film).

### (Production of Negative Electrode Mixture Layer Part)

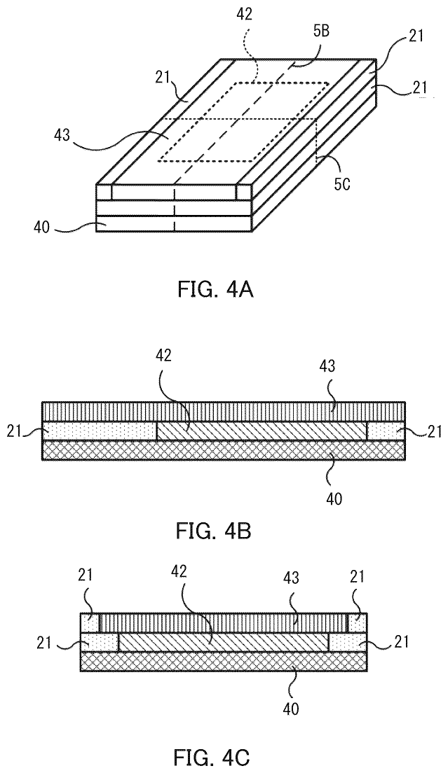

FIGS. 4A to 4C are schematic views illustrating an example of a produced negative electrode mixture layer part. FIG. 4A is a schematic perspective view of the negative electrode mixture layer part, FIG. 4B is a schematic cross-sectional view along line 5B in FIG. 4A, and FIG. 4C is a schematic cross-sectional view along line 5C in FIG. 4A.

The negative electrode mixture layer part can be produced in the same manner as the positive electrode mixture layer part described above. Thus, it is possible to obtain a negative electrode mixture layer part in which support 40, negative electrode mixture layer 42 and protective material layer 21 around negative electrode mixture layer 42, and electrolyte mixture layer 43 and protective material layer 21 outside electrolyte mixture layer 43 are stacked in this order (FIGS. 4A to 4C).

### (Formation of Stacked Body)

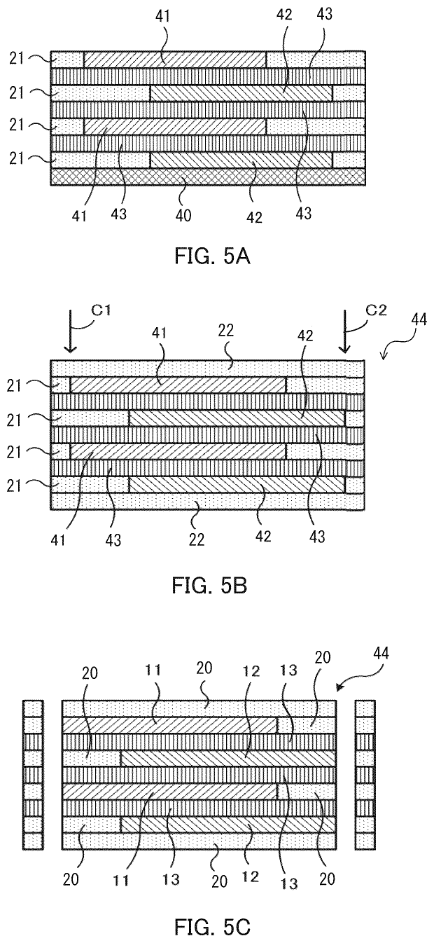

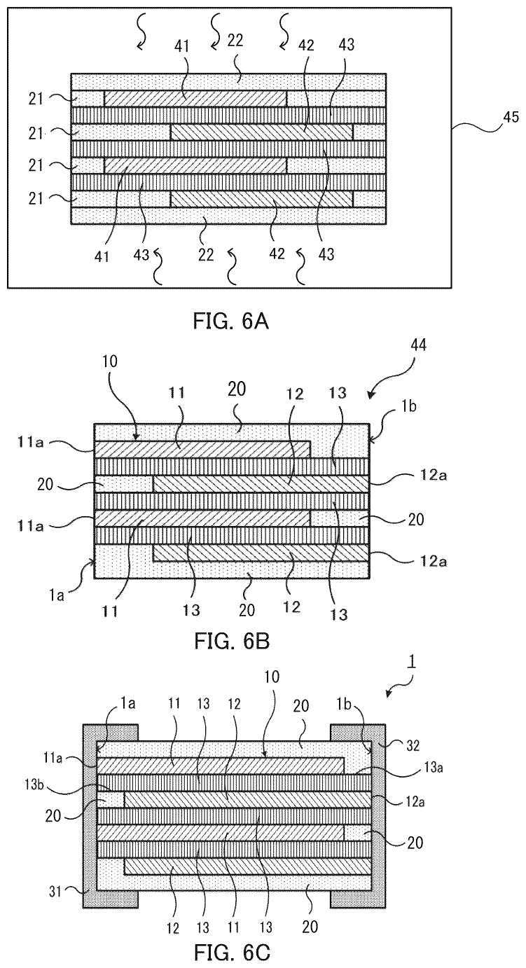

FIGS. 5A to 5C and FIGS. 6A to 6C are schematic views illustrating exemplary steps of producing solid-state battery main body 10.

The positive electrode mixture layer parts and the negative electrode mixture layer parts produced as described above are stacked. For example, on the negative electrode mixture layer part with support 40 illustrated in FIG. 4B, a positive electrode mixture layer part obtained by peeling support 40 from the positive electrode mixture layer part illustrated in FIG. 3B is stacked, then a negative electrode mixture layer part obtained by peeling support 40 from negative electrode mixture layer part illustrated in FIG. 4B is stacked, and then a positive electrode mixture layer part obtained by peeling support 40 from the positive electrode mixture layer part illustrated in FIG. 2C is stacked thereon (see FIG. 5A). Then, support 40 is peeled from the obtained stacked body, protective sheet 22 is stacked on the lower side and on the upper side, and these are thermocompression-bonded under conditions of a predetermined pressure and temperature to form stacked body 44 (see FIG. 5B).

The stacking of the positive electrode mixture layer part and the negative electrode mixture layer part is performed in such a way that negative electrode mixture layer 42 and positive electrode mixture layer 41 facing each other with electrolyte mixture layer 43 therebetween partially overlap with each other. Further, the number of stacked layers can be set according to the required performance (such as battery capacity).

In this manner, stacked body 44 including positive electrode mixture layer 41, negative electrode mixture layer 42, and electrolyte mixture layer 43 interposed therebetween, and protective material layer 21 and protective sheet 22 is formed (see FIG. 5B).

### (Adjustment of Capacity Ratio)

In the present step in the present embodiment, the stacked body is formed in such a way that the ratio (negative electrode capacity/positive electrode capacity) of the charging capacity of negative electrode mixture layer 42 to the charging capacity of positive electrode mixture layer 41 included in the stacked body fired in the next step is 0.7 or more and 1.0 or less. The discharging capacities of the positive electrode layer and the negative electrode layer after firing match the above-described charging capacities. For example, the thickness of a positive electrode mixture layer part and the thickness of a negative electrode mixture layer part may be adjusted, or the number of layers of positive electrode mixture layer parts and the number of layers of negative electrode mixture layer parts may be adjusted so that the above-described ratio becomes 0.7 or more and 1.0 or less, based on the theoretical capacity of the positive electrode active material in the positive electrode paste (positive electrode mixture layer part) and the content of the positive electrode active material, and the theoretical capacity of the negative electrode active material in the negative electrode paste (negative electrode mixture layer part) and the content of the negative electrode active material.

### 3) Step of Firing Stacked Body

Next, the obtained stacked body 44 is cut at predetermined positions C1 and C2 as necessary (see FIG. 5B). Then, the obtained stacked body 44 is fired at a predetermined temperature (see FIGS. 6A and 6B).

### (Degreasing/Firing)

Stacked body 44 is subjected to heat treatment under conditions of a predetermined atmosphere, temperature, and time. The heat treatment can be performed, for example, in heat treatment furnace 45. Specifically, a heat treatment is performed for degreasing, which mainly burns off organic components such as a binder, and a heat treatment is performed for firing, which mainly sinters a solid electrolyte and a protective material.

The heat treatment for degreasing can be performed, for example, in an atmosphere containing oxygen, at 200° C. to 500° C. for 1 to 30 hours, preferably at 500° C. for 10 hours. The heat treatment for firing can be performed, for example, in an atmosphere containing nitrogen or oxygen, at 500° C. to 700° C., for 0.5 to 10 hours, preferably at 600° C. for 2 hours.

The heat treatment for firing sinters the solid electrolyte in electrolyte mixture layer 43 included in stacked body 44 and the solid electrolytes in positive electrode mixture layer 41 and negative electrode mixture layer 42. Further, the heat treatment for firing sinters protective material layer 21 and protective sheet 22 included in stacked body 44, thereby integrating them with each other. As a result, a sintered body of stacked body 44 including positive electrode layers 11, negative electrode layers 12, solid electrolyte layers 13, and protection layers 20 is formed (see FIG. 6B).

The cut surface of the sintered body of stacked body 44 at position C1 becomes positive electrode lead-out surface 1a, and end surface 11a of positive electrode layer 11 exposed from positive electrode lead-out surface 1a is connected to external electrode 31. The cut surface of the sintered body of stacked body 44 at position C2 becomes negative electrode lead-out surface 1b, and end surface 12a of negative electrode layer 12 exposed from negative electrode lead-out surface 1b is connected to external electrode 32. As a result, solid-state battery main body 10 can be obtained (see FIG. 6B).

### (Formation of External Electrode)

In the obtained sintered body of stacked body 44, external electrode 31 is formed on positive electrode lead-out surface 1a, and an external electrode 32 is formed on negative electrode lead-out surface 1b. External electrode 31 and external electrode 32 are formed, for example, by a method of applying, drying, and curing a conductive paste, or by a method of depositing a metal by sputtering, plating, or the like. As a result, solid-state battery 1 is obtained (see FIG. 6C).

### 3. Variations

In the above embodiment, solid-state battery main body 10 includes a plurality of each of positive electrode layers 11, negative electrode layers 12, and solid electrolyte layers 13. However, the present invention is not limited to this, and a single layer may be provided as each of positive electrode layers 11, negative electrode layers 12, and solid electrolyte layers 13. Further, the numbers of positive electrode layers 11, negative electrode layers 12, and solid electrolyte layers 13 are not limited to those in the above-described embodiment, and may be appropriately set according to the required characteristics.

Further, in the above embodiment, an oxide solid electrolyte, preferably LAGP, is used as the solid electrolyte for solid electrolyte layer 13, positive electrode layer 11, and negative electrode layer 12. The LAGP may be amorphous LAGP, crystalline LAGP, or a combination thereof.

Further, in addition to LAGP, other oxide solid electrolytes may be used, such as Li_{1.3}Al_{0.3}Ti_{1.7}(PO₄)₃, which is a type of NASICON-type LATP (general formula Li₁₊₂Al_{z}Ti_{2-z}(PO₄)₃, 0<z≤1), garnet-type lithium lanthanum zirconate (Li₇La₃Zr₂O₁₂, hereinafter referred to as “LLZ”), perovskite-type lithium lanthanum titanate (Li_{0.5}La_{0.5}TiO₃, hereinafter referred to as “LLT”), and partially nitrided γ-lithium phosphate (γ-Li₃PO₄, hereinafter referred to as “LiPON”).

Solid electrolyte layer 13, positive electrode layer 11, and negative electrode layer 12 may be made of the same type of oxide solid electrolyte, or may be made of different types of oxide solid electrolytes. Each of solid electrolyte layers 13, positive electrode layers 11, and negative electrode layers 12 may be made of one type of oxide solid electrolyte or may be made of two or more types of oxide solid electrolytes.

Further, in the above embodiment, protective material layer 21 serving as the embedding layer and protective sheets 22 disposed on the lower side and the upper side of stacked body 44 may be formed of protection pastes having the same composition or may be formed of protection pastes having different compositions.

### EXAMPLES

Hereinafter, the present invention will be further described with reference to Examples. However, the technical scope of the present invention is not limited to these

### Examples.

### 1. Production of Solid-State Battery

### Example 1

### 1-1. Preparation of Paste

### 1-1-1. Preparation of Positive Electrode Paste

The following materials were used: 11.8 parts by mass of Li₂CoP₂O₇ powder (LCPO powder) as a positive electrode active material, 17.7 parts by mass of amorphous Li_{1.5}Al_{0.5}Ge_{1.5}(PO₄)₃ powder (LAGPg powder) as a solid electrolyte, 2.7 parts by mass of vapor-grown carbon fiber powder (VGCF powder) as a conductive additive, 7.8 parts by mass of polyvinyl butyral as a binder, 0.3 parts by mass of triethylene glycol bis(2-ethylhexanoate) (G-260, manufactured by Sumitomo Chemical Co., Ltd.) as a plasticizer, 0.6 parts by mass of HIPLAAD ED350 (manufactured by Kusumoto Chemicals, Ltd., HIPLAAD is a registered trademark of the company) as a dispersant, and 59.1 parts by mass of terpineol as a diluent. After mixing these materials in a ball mill for 72 hours, the mixture was further mixed and dispersed using a three-roll mill. The dispersion was continued until the material agglomerates were reduced to 1 μm or less by using a particle gauge, thereby forming a positive electrode paste.

### 1-1-2. Preparation of Negative Electrode Paste

A negative electrode paste was obtained in the same manner as the preparation of the positive electrode paste, except that anatase-type titanium oxide was used in the same amount as the negative electrode active material instead of the positive electrode active material.

### 1-1-3. Preparation of Electrolyte Paste

The following materials were used: 29.0 parts by mass of amorphous Li_{1.5}Al_{0.5}Ge_{1.5}(PO₄)₃ powder (LAGPg powder) and 3.2 parts by mass of crystalline Li_{1.5}Al_{0.5}Ge_{1.5}(PO₄)₃ powder (LAGPc powder) as a solid electrolyte, 6.2 parts by mass of polyvinyl butyral as a binder, 2.2 parts by mass of triethylene glycol bis(2-ethylhexanoate) (G-260, manufactured by Sumitomo Chemical Co., Ltd.) as a plasticizer, 0.3 parts by mass of HIPLAAD ED350 (manufactured by Kusumoto Chemicals, Ltd.) as a dispersant, and 59.1 parts by mass of terpineol as a diluent. After mixing these materials in a ball mill for 72 hours, the mixture was further mixed and dispersed using a three-roll mill. The dispersion was continued until the material agglomerates were reduced to 1 μm or less by using a particle gauge, thereby forming an electrolyte paste.

### 1-2. Production of Solid-State Battery

### 1-2-1. Production of Positive Electrode Mixture Layer Part

The electrolyte paste was pattern-printed on a PET film by a screen printing method and dried at 90° C. for 5 minutes. The positive electrode paste was pattern-printed on the electrolyte paste by the screen printing method and dried at 90° C. for 5 minutes. Next, the electrolyte paste (embedding paste) was printed around the pattern-printed positive electrode paste by the screen printing method, and then dried at 90° C. for 5 minutes. These operations were repeated until the predetermined thickness was achieved. As a result, a positive electrode mixture layer part having a stacked structure of PET film/electrolyte mixture layer/positive electrode mixture layer and an electrolyte mixture layer around the positive electrode mixture layer was produced.

### 1-2-2. Production of Negative Electrode Mixture Layer Part

A negative electrode mixture layer part was produced in the same manner as the positive electrode mixture layer part, except that the negative electrode paste was used instead of the positive electrode paste. As a result, a negative electrode mixture layer part having a stacked structure of PET film/electrolyte mixture layer/negative electrode mixture layer and an electrolyte mixture layer around the negative electrode mixture layer was produced.

### 1-2-3. Production of Upper-Side Cover and Lower-Side Cover

The electrolyte paste was printed solidly (over the entire surface) on a PET film and then dried to produce an upper-side cover and a lower-side cover each having a stacked structure of PET film/electrolyte mixture layer.

1-2-4. Production of Stacked body

The positive electrode mixture layer part produced above was stacked on the electrolyte mixture layer of the lower-side cover produced above in such a way that the positive electrode mixture layer was in contact with the electrolyte mixture layer of the lower surface cover, and the positive electrode mixture layer/electrolyte mixture layer was transferred by thermocompression bonding.

Next, the negative electrode mixture layer part was stacked on the transferred electrolyte mixture layer in such a way that the negative electrode mixture layer was in contact with the electrolyte mixture layer, and the negative electrode mixture layer/electrolyte mixture layer was transferred by thermocompression bonding.

The transfer of the positive electrode mixture layer part and the negative electrode mixture layer part described above was repeated until the number of the stacked layers reached a predetermined number (10 layers). Finally, the upper-side cover was stacked in the same manner, thermocompression-bonded, and transferred.

The conditions of the thermocompression bonding were set to 20 MPa and 70° C. As a result, a stacked body having a stacked structure as illustrated in FIGS. 1B and 1C was obtained.

After cutting the obtained stacked body to have a planar dimension of 4.5 mm×3.2 mm, the cut stacked body was placed flat on a porous ceramic plate and heated at 500° C. for 1 hour in an atmospheric environment to perform the binder component degreasing. Subsequently, the stacked body was heated at 600° C. for 2 hours in a nitrogen atmosphere to fire the stacked body. The thickness of the positive electrode layer after firing was 18 μm, and the thickness of the negative electrode layer after firing was 12 μm.

An external electrode was formed to cover a lead-out section of the obtained stacked body after firing. The external electrode was formed by applying a main material containing silver and then performing Ni plating and Sn plating on the surface thereof. As a result, a solid-state battery as illustrated in FIGS. 1A to 1C was produced.

### Example 2

A solid-state battery was produced in the same manner as in Example 1, except that the thicknesses of the positive electrode mixture layer part and the negative electrode mixture layer part were changed. The thickness of the positive electrode layer after firing was 14.3 μm, and the thickness of the negative electrode layer after firing was 11 μm.

### Example 3

A solid-state battery was produced in the same manner as in Example 1, except that the thicknesses of the positive electrode mixture layer part and the negative electrode mixture layer part were changed. The thickness of the positive electrode layer after firing was 20 μm, and the thickness of the negative electrode layer was 16 μm.

### Example 4

A solid-state battery was produced in the same manner as in Example 1, except that the amount of the negative electrode active material (anatase-type titanium oxide) added during the preparation of the negative electrode paste was 9.38 parts by mass, the added amount of the LAGPg powder among the solid electrolytes was 20.12 parts by mass, and the thicknesses of the positive electrode mixture layer part and the negative electrode mixture layer part were changed. The thickness of the positive electrode layer after firing was 18.3 μm, and the thickness of the negative electrode layer after firing was 14.5 μm.

### Comparative Example 1

A solid-state battery was produced in the same manner as in Example 1, except that the thicknesses of the positive electrode mixture layer part and the negative electrode mixture layer part were changed. The thickness of the positive electrode layer after firing was 22 μm, and the thickness of the negative electrode layer after firing was 12 μm.

### Comparative Example 2

A solid-state battery was produced in the same manner as in Example 1, except that the thicknesses of the positive electrode mixture layer part and the negative electrode mixture layer part were changed. The thickness of the positive electrode layer after firing was 10.3 μm, and the thickness of the negative electrode layer after firing was 11 μm.

### Comparative Example 3

A solid-state battery was produced in the same manner as in Example 1, except that the thicknesses of the positive electrode mixture layer part and the negative electrode mixture layer part were changed. The thickness of the positive electrode layer after firing was 11 μm, and the thickness of the negative electrode layer after firing was 16 μm.

### Comparative Example 4

A solid-state battery was produced in the same manner as in Example 1, except that the thicknesses of the positive electrode mixture layer part and the negative electrode mixture layer part were changed. The thickness of the positive electrode layer after firing was 10.8 μm, and the thickness of the negative electrode layer after firing was 15.8 μm.

### Comparative Example 5

A solid-state battery was produced in the same manner as in Example 1, except that the thicknesses of the positive electrode mixture layer part and the negative electrode mixture layer part were changed. The thickness of the positive electrode layer after firing was 18.5 μm, and the thickness of the negative electrode layer after firing was 13.8 μm.

Table 1 shows, for each solid-state battery, the thicknesses of the positive electrode layer and the negative electrode layer after firing, the ratio of the thickness of the negative electrode layer to the thickness of the positive electrode layer (negative electrode thickness/positive electrode thickness), the charging capacities of the positive electrode layer and the negative electrode layer, and the ratio (negative electrode capacity/positive electrode capacity) of the charging capacity of the negative electrode layer to the charging capacity of the positive electrode layer.

TABLE 1

| | Thickness | | | Charging capacity | | |
|---|---|---|---|---|---|---|
| | | | Ratio | | | Ratio |
| | Positive | Negative | (negative | Positive | Negative | (negative |
| | electrode | electrode | electrode/ | electrode | electrode | electrode/ |
| | layer | layer | positive | layer | layer | positive |
| | (μm) | (μm) | electrode) | (μAh) | (μAh) | electrode) |
| Example 1 | 18 | 12 | 0.7 | 235 | 174 | 0.74 |
| Example 2 | 14.3 | 11 | 0.8 | 185 | 174 | 0.94 |
| Example 3 | 20 | 16 | 0.8 | 243 | 234 | 0.96 |
| Example 4 | 18.3 | 14.5 | 0.8 | 243 | 195 | 0.80 |
| Comparative | 22 | 12 | 0.5 | 268 | 174 | 0.65 |
| Example 1 | | | | | | |
| Comparative | 10.3 | 11 | 1.1 | 128 | 174 | 1.36 |
| Example 2 | | | | | | |
| Comparative | 11 | 16 | 1.5 | 185 | 234 | 1.26 |
| Example 3 | | | | | | |
| Comparative | 10.8 | 15.8 | 1.5 | 127 | 234 | 1.84 |
| Example 4 | | | | | | |
| Comparative | 18.5 | 13.8 | 0.7 | 185 | 195 | 1.05 |
| Example 5 | | | | | | |

### 2. Evaluation (Charge-Discharge Cycle Test)

Each of the produced solid-state battery was subjected to 60 cycles of charge and discharge under the following conditions.

### (Charging Condition)

The charging was performed in a constant current-constant voltage (CC-CV) charging mode. The maximum current rate in the CC charging mode was set to 1 C, and the end condition for the CV charging mode was set to 3 hours from the start of the CV mode. The charging upper limit voltage in the CV charging mode was set to 3.4 V.

### (Discharge Condition)

The discharge was performed in a CC discharge mode. The current rate was set to 0.2 C, and the termination voltage was set to 1V. The charge-discharge test was conducted at 85° C.

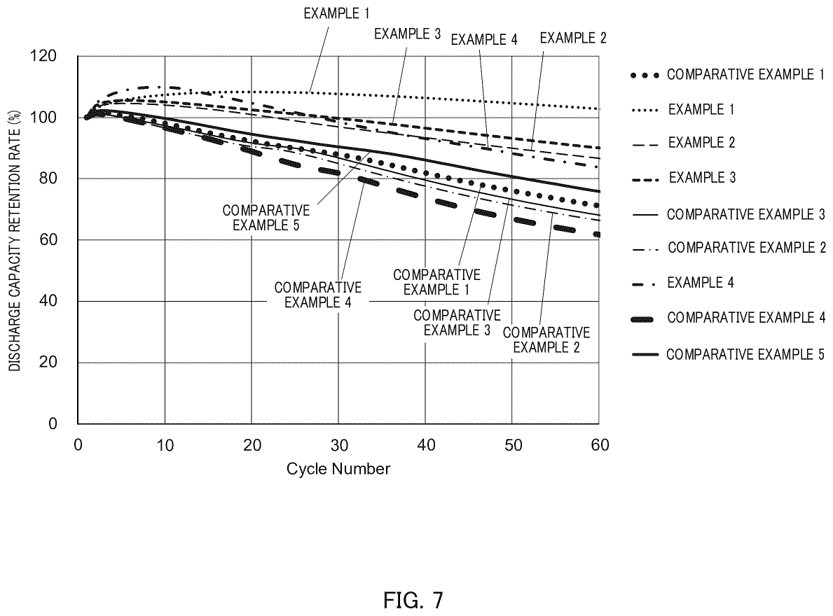

The ratio of the discharge capacity in each cycle to the initial discharge capacity (μAh) was calculated, and the discharge capacity retention rate in each cycle was determined. FIG. 7 illustrates the relationship between the number of cycles and the discharge capacity retention rate for each solid-state battery.

As is apparent from FIG. 7, a solid-state battery with the ratio (negative electrode capacity/positive electrode capacity) of the charging capacity of the negative electrode layer to the charging capacity of the positive electrode layer of 0.74 or more and 0.96 or less exhibited satisfactory charge-discharge cycle characteristics.

The present application is entitled to and claims the benefit of Japanese Patent Application No. 2022-156663, filed on Sep. 29, 2022, the disclosure of which including the specification, claims, and drawings is incorporated herein by reference in its entirety.

### INDUSTRIAL APPLICABILITY

The present invention can provide a solid-state battery that can be applied to a solid-state battery using an oxide-based solid electrolyte, enhances cycle characteristics, and does not require an additional configuration such as a conductive resin layer. The present invention can also provide a method for producing the solid-state battery.

### REFERENCE SIGNS LIST

1 Solid-state battery
1a Positive electrode lead-out surface
1b Negative electrode lead-out surface
10 Solid-state battery main body
11 Positive electrode layer
12 Negative electrode layer
13 Solid electrolyte layer
11a, 12a End surface
13a One surface
13b Other surface
20 Protection layer
21 Protective material layer
22 Protective sheet
31, 32 External electrode
40 Support
41 Positive electrode mixture layer
42 Negative electrode mixture layer
43 Electrolyte mixture layer
44 Stacked body

1. A solid-state battery comprising:
a positive electrode layer;
a negative electrode layer; and
a solid electrolyte layer disposed between the positive electrode layer and the negative electrode layer,
wherein
a ratio (negative electrode capacity/positive electrode capacity) of a charging capacity of the negative electrode layer to a charging capacity of the positive electrode layer is 0.74 or more and 0.96 or less.

2. The solid-state battery according to claim 1, wherein
a ratio (negative electrode thickness/positive electrode thickness) of a thickness of the negative electrode layer to a thickness of the positive electrode layer is 0.7 or more and 0.8 or less.

3. The solid-state battery according to claim 1, wherein
the positive electrode layer includes an oxide solid electrolyte.

4. The solid-state battery according to claim 1, wherein
the positive electrode layer includes lithium metal phosphate.

5. A method for producing a solid-state battery, the method comprising:
forming a stacked body, the stacked body including a positive electrode mixture layer, a negative electrode mixture layer, and an electrolyte mixture layer disposed between the positive electrode mixture layer and the negative electrode mixture layer; and
firing the stacked body,
wherein
in the stacked body fired, a ratio (negative electrode capacity/positive electrode capacity) of a charging capacity of the negative electrode mixture layer to a charging capacity of the positive electrode mixture layer is 0.74 or more and 0.96 or less.

6. The method according to claim 5, wherein
in the stacked body fired, a ratio (negative electrode thickness/positive electrode thickness) of a thickness of the negative electrode mixture layer to a thickness of the positive electrode mixture layer is 0.7 or more and 0.8 or less.

7. The method according to claim 5, wherein
the positive electrode mixture layer includes an oxide solid electrolyte.

8. The method according to claim 5, wherein
the positive electrode mixture layer includes lithium metal phosphate.
